(19) United States
(12) Patent Application Publication
(10) Pub. No.: US 2026/0044552 A1
(43) Pub. Date: Feb. 12, 2026

(54) KNOWLEDGE RETRIEVAL DURING ONLINE COMMUNICATION SESSIONS

(71) Applicant: Cisco Technology, Inc., San Jose, CA (US)

(72) Inventors: Peter Hraška, Bratislava (SK); Andrej Švec, Bratislava (SK); Miriama Krížková, Bratislava (SK); Marek Šuppa, Jacovce (SK)

(21) Appl. No.: 18/800,297

(22) Filed: Aug. 12, 2024

(51) Int. Cl. G06F 16/34; G06F 16/683; G06F 16/783; H04L 12/18

(52) U.S. Cl. CPC G06F 16/345; G06F 16/685; G06F 16/7844

(57) ABSTRACT

A request for information from a participant of a plurality of participants in a communication session is identified. In response to the request for information, it is determined that an uncertainty level among the plurality of participants is above a threshold level. A search is performed for the information based on identifying that the uncertainty level is above the threshold level, and one or more search results associated with the information is displayed to the plurality of participants.

### TECHNICAL FIELD

The present disclosure relates to online communication sessions.

### BACKGROUND

In organizational settings, answers to some questions or requests for information may be unavailable due to limitations of human memory and communication inefficiencies. Meetings and discussions may occur, but pertinent information may not be readily available to meeting participants or decision makers, which may lead to potential redundancy, misinformation, and suboptimal outcomes. Providing contextual information associated with a topic that is being discussed may be helpful and potentially lead to conducting fewer additional meetings.

### BRIEF DESCRIPTION OF THE DRAWINGS

FIG. 1 is a block diagram of a system configured to provide information associated with a topic being discussed to participants of an online communication session, according to an example embodiment.

FIG. 2 is a diagram illustrating the modules of a knowledge retrieval system, according to an example embodiment.

FIG. 3 is a diagram illustrating an exemplary user interface in which an online communication session is being monitored by a knowledge retrieval system, according to an example embodiment.

FIG. 4 is a diagram illustrating an exemplary user interface in which information is requested during an online communication session, according to an example embodiment.

FIG. 5 is a diagram illustrating an exemplary user interface in which an uncertainty cue among participants of an online communication session is identified, according to an example embodiment.

FIG. 6 is a diagram illustrating an exemplary user interface in which results associated with a request for information are displayed during an online communication session, according to an example embodiment.

FIG. 7 is a flow diagram illustrating a method of presenting search results in response to a request for information during an online communication session, according to an example embodiment.

FIG. 8 is a hardware diagram of a computer device that may be configured to perform the features involved in presenting search results in response to a request for information during an online communication session, according to an example embodiment.

### DETAILED DESCRIPTION

### Overview

In one embodiment, a computer-implemented method is provided for presenting one or more search results associated with requested information to a plurality of participants in a communication session. The method includes identifying, from a participant of a plurality of participants in a communication session, a request for information. The method includes determining, in response to the request for information, that an uncertainty level among the plurality of participants is above a threshold level. The method further includes performing a search for the information based on identifying that the uncertainty level is above the threshold level, and presenting one or more search results associated with the information to the plurality of participants.

### Example Embodiments

Knowledge retention and retrieval may present challenges during online communication sessions. For example, if a participant poses a question or requests information and other participants do not know the information or cannot remember an answer to the question, redundancy, misinformation, and suboptimal outcomes may occur. In addition, not having an answer to a question may create an awkward situation during a communication session because knowing the answer may help speed up the meeting and help participants get more value out of the meeting. Searching for the requested information may be quite time consuming and the searching may slow everyone down. In some situations, additional communication sessions may have to be scheduled after the requested information is available.

Presented herein are techniques that address the challenge of knowledge retention and retrieval within organizations by leveraging advanced technology to analyze multimodal cues in real-time communication sessions. Embodiments presented herein provide a system that comprises multiple modules designed to enhance decision-making processes and facilitate knowledge dissemination.

According to embodiments described herein, an online communication scenario or session (e.g., an online audio meeting, an online video meeting, an online chat discussion or text space, etc.) may be observed or monitored in real-time. When a participant asks a question or requests information, a level of uncertainty among the other participants may be observed in real time. For example, uncertainty cues may be detected if the other participants do not know the answer to the question or do not have the information requested. If uncertainty cues are detected or an uncertainty level is above a threshold level, an organizational knowledge base may be searched to identify results associated with the question or the request for information.

According to the embodiments, a relevancy of the search results for the topic that is currently being discussed may be determined. If both the uncertainty level and relevancy of the retrieved context meet a certain threshold level (e.g., separately or combined), the contextually relevant information may be displayed to users.

In addition, the participants may indicate how relevant particular search results are to the current discussion. The participant feedback may be used when performing subsequent searches for information associated with topics of subsequent online communication sessions.

Thus, present embodiments improve the technical field of online communication sessions by providing participants with search results relevant to topics of conversation or information requested during the communication session. Present embodiments therefore increase the efficiency of online communication sessions by presenting information quickly and without requiring participants to stop and perform a lookup of the information. Thus, present embodiments provide the practical application of an online communication session system that automatically determines when there is uncertainty associated with a request for information, performs a search for information associated with the request, and displays relevant search results without user or participant instructions.

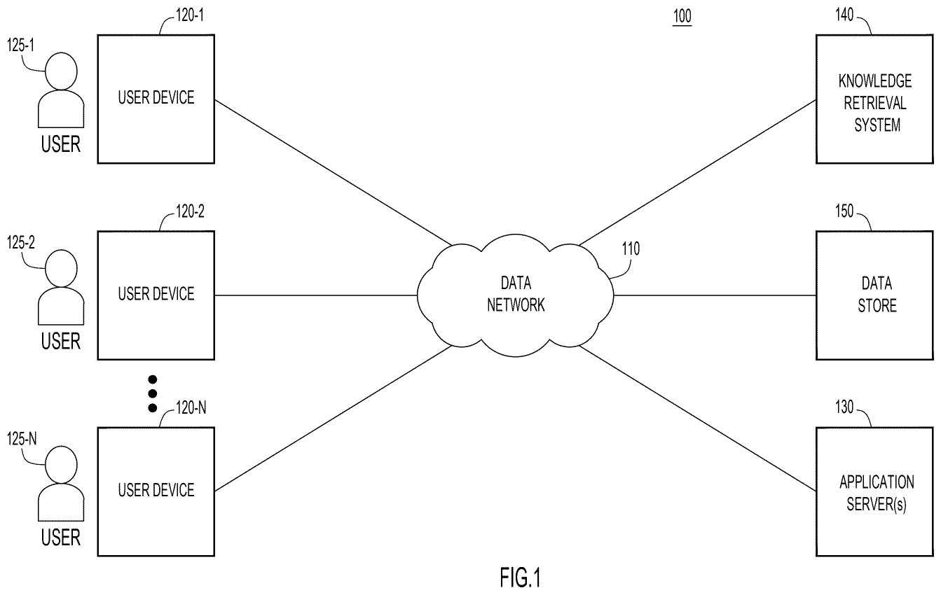

Reference is first made to FIG. 1. FIG. 1 shows a block diagram of a system 100 that is configured to provide search results associated with a request for information during an online communication session in response to an uncertainty cue being identified. The system 100 includes one or more application server(s) 130, a plurality of user devices 120-1, 120-2, . . . , 120-N that communicate with the application server(s) 130 via one or more networks 110, a knowledge retrieval system 140, and a data store 150. Each user device 120-1 to 120-N is associated with a user 125-1, 125-2, . . . , 125-N.

The application server(s) 130 is configured to provide an online communication service for hosting a communication session among user devices 120-1 to 120-N. The application server(s) 130 may be associated with an online meeting application (e.g., an online audio meeting application, an online video meeting application, etc.), an online text-based communication application (e.g., an online texting application, an online meeting space application, an online team communications application, etc.), or another type of online communications application.

Each of user devices 120-1 to 120-N may be a tablet, laptop computer, desktop computer, Smartphone, virtual desktop client, virtual whiteboard, or any user device now known or hereinafter developed. User devices 120-1 to 120-N may have a dedicated physical keyboard or touch-screen capabilities to provide a virtual on-screen keyboard to enter text. User devices 120-1 to 120-N have the capability to send and receive electronic communications (e.g., emails, chats, messaging communications received via a messaging application or messaging web-service, etc.). For example, users 125-1 to 125-N may use user devices 120-1 to 120-N to send electronic communications to and receive electronic communications from application server(s) 130.

Knowledge retrieval system 140 may be configured to monitor online communication sessions and provide knowledge-based information based on a topic of the online communication session or information requested during the online communication session. Although FIG. 1 illustrates knowledge retrieval system 140 as being separate from application server(s) 130, knowledge retrieval system 140 may be a part of or incorporated in application server(s) 130.

In the example illustrated in FIG. 1, users 125-1 to 125-N may enter an online communication (e.g., an audio-based communication session, a video-based communication session, a text-based communication session, etc.) using user devices 120-1 to 120-N and knowledge retrieval system 140 may monitor, observe, or listen to the online communication session. For example, the knowledge retrieval system 140 may observe topics and keywords that are being discussed as well as identify when information is requested and/or when participants display uncertainty cues.

In the example illustrated in FIG. 1, a user 125-1 may ask a question or request information during the online communication session and other users 125-2 to 125-N may be uncertain of the answer to the question or may not know the requested information. Knowledge retrieval system 140 may observe the uncertainty via, for example, breaks in the discussion, an uncertainty in tones of voices of the participants, a change in the pace of speech, an increase in filler words being used, etc.

If an uncertainty cue is detected or an uncertainty level is above a threshold level, knowledge retrieval system 140 may perform a contextual search within data store 150 to identify results associated with the information that was requested or the topic of conversation being discussed. Data store 150 may be a knowledge database of a given group of people (e.g., users associated with a company or corporation, users associated with a particular application, etc.). The data store 150 may store information associated with, for example, previous recordings (e.g., previously recorded meetings), message histories in messaging applications, documents, videos, transcripts, files, codebases, etc. associated with the group of people.

If knowledge retrieval system 140 determines that there is a strong match of the contextual search with the topic that is currently being discussed and, at the same time, the uncertainty level is high (e.g., above a threshold level), a full contextual search may be performed and contextual help (e.g., search results associated with the topic or requested information) may be provided. In some embodiments, core information associated with the topic and/or requested information may be extracted and presented to the users 125-1 to 125-N in a short-form fashion for easy digestibility. In addition, references (e.g., links, timestamped videos, quotes, etc.) to where the information was located may also be provided.

In some embodiments, users 125-1 to 125-N may mark each provided search result as relevant or irrelevant to the current discussion. Knowledge retrieval system 140 may be trained using this participant feedback. In this way, knowledge retrieval system 140 may become smarter and more robust in the future as more knowledge-based results are provided and participant feedback is received.

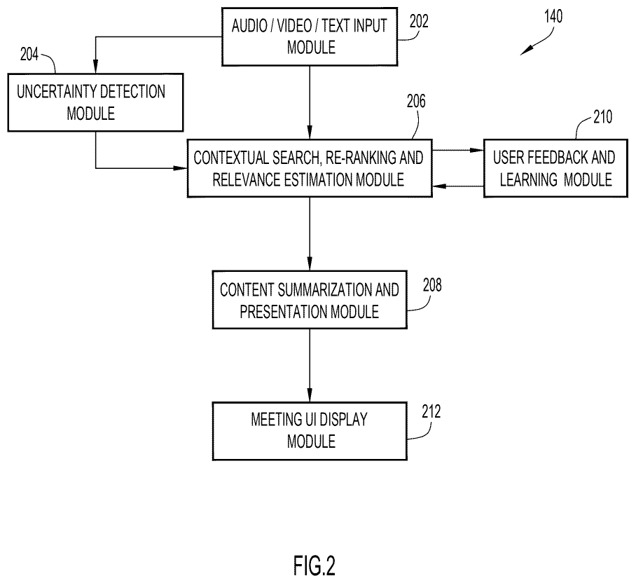

Reference is now made to FIG. 2. FIG. 2 is a block diagram illustrating an overview of knowledge retrieval system 140 in terms of its modules and their functionality. FIG. 2 additionally illustrates the relationships between the modules of knowledge retrieval system 140. As illustrated in FIG. 2, the knowledge retrieval system 140 includes an audio/video/text input module 202, an uncertainty detection module 204, a contextual search, re-ranking and relevance estimation module 206, a content summarization and presentation module 208, a user feedback and learning module 210, and a meeting user interface (UI) display module 212.

Audio/video/text input module 202 may monitor or observe the online communication session and capture audio, video, and/or text input from the online communication session. For example, for an online videoconference, audio/video/text input module 202 may capture audio and/or video of the participants speaking, audio, video, and/or text of shared content, text of messages shared during the videoconference, etc. For an online messaging session, audio/video/text input module 202 may capture text of the messages being exchanged.

The audio/video/text may be converted to a representation that may be processed by uncertainty detection module 204. The conversion may include, for example, splitting or dividing the audio, video, and/or text input into chunks or segments that may be passed through a pre-trained machine learning module that may generate high dimensional representations that can be processed by the other modules of the knowledge retrieval system 140. Although audio, video, and text are different modalities, they can be combined, for instance, by converting the audio input to a series of spectrograms that can be interpreted as a series of images. In some embodiment, the audio/video/text may be converted into other formats that can be processed by the other modules using different methods or mechanisms.

Uncertainty detection module 204 may receive the representations from the audio/video/text input module 202 and may use machine learning-based algorithms to identify patterns and/or behaviors indicative of uncertainty in the online communication session. The patterns or behaviors of uncertainty may include, for example, increased usage of filler words, hesitation, confusion, etc. The uncertainty cues may be identified, for example, in response to a question asked or information requested during the online communication session or while a topic is being discussed.

The increased usage of filler words may be measured, for example, based on the number of filler words (e.g., “um,” “uh,” “you know,” etc.) identified in the real-time communication session transcript per second. The hesitation may be identified, for example, based on a significant decrease of the speech tempo, an increased length of pauses between utterances, or slower and irregular pauses in general. Confusion may be identified, for example, based on a sudden increase or decrease in pitch and/or volume, an unusual intonation, or a shaky voice.

In some embodiments, the uncertainty level may be quantified as a combination of the increase usage of filler words, hesitation, and/or confusion and used as a threshold for triggering contextual searches. For example, an uncertainty level may be calculated based on the above-described uncertainty cues and compared to an uncertainty threshold level. If the calculated uncertainty level is above the uncertainty threshold level, a contextual search may be triggered. The threshold level may be, for example, estimated from longer-term use, set at a default value, be configured by a user, etc.

Contextual search, re-ranking and relevance estimation module 206 may perform a search within a knowledge database, such as data store 150, for information in, for example, previous recordings, message history, transcripts, documents, videos, codebase, past decisions, etc. The search may be performed using keywords and topics extracted from the meeting discussion. For example, the keywords may be extracted based on a topic that was discussed when information was requested and the uncertainty cues were identified. In some embodiments, the search may be performed to present information to answer a question or to provide additional information about a topic being discussed. The search may be performed as a retrieval against the knowledge database using both sparse and dense retrievers.

Because a list of potentially matching documents may be exhaustive and much larger than the space provided in an online communication UI display, the contextual search, re-ranking and relevance estimation module 206 may employ reranking that receives the results of the performed searches as well as the output of the audio/video/text input module 202 and the uncertainty detection module 204 as an input and outputs a rearranged list of items from the knowledge database. The rank of the search result items that have the largest chance to clarify the potential confusion that the meeting participants are experiencing at a particular point in the meeting may be boosted while the other search result items may be deprioritized (e.g., a ranking of the other search result items may be lowered). The reranking may filter the search results to produce a fewer number of search results.

Although the search result items rearranged based on the priority or ranking may identify search result items that are more relevant than other search result items, it may still be important to assess the relevance of the search result items to the current conversation. To assess the relevance, a speaker impersonation technique may be employed in which each of the speakers may be impersonated by a large language model (LLM) using artificial intelligence technology. For example, a persona of a specific speaker or participant may be built from a transcript of past communication sessions and the persona may be used at a system prompt for training the LLM based on the participant's persona. The persona-based prompt may be used to estimate, for each of the identified search result items, whether the search result item is likely to clarify the confusion identified during the communication session. For example, if user 125-1 has asked a question about a specific concept, an LLM impersonating the persona of user 125-1 may analyze each identified search result item and determine how well the search result item addresses the query.

To further enhance the quality of the LLM's reasoning, chain-of-thought prompting may be employed. This technique involves generating a sequence of follow-up prompts that are based on the output of the previous prompt. For example, if an LLM impersonating the persona of user 125-1 determines that a certain document is relevant to addressing the participants' confusion, the LLM may generate a series of follow-up prompts that probe the content of the document and assess the document's relevance to the current conversation, topic being discussed, or information requested. The identified search results may be filtered based on the output of the LLM. For example, the most pertinent search results may be identified based on the speaker impersonation and chain-of-thought prompting.

By employing speaker impersonation and chain-of-thought prompting, knowledge retrieval system 140 may leverage the power of LLMs to provide more informed and contextual search results that take into account the nuances of human communication. In this way, knowledge retrieval system 140 may better support meeting/communication session participants in clarifying their confusing and making more informed decisions.

As illustrated in FIG. 2, content summarization and presentation module 208 may receive information from contextual search, re-ranking and relevance estimation module 206. Content summarization and presentation module 208 may extract core information from the search results and present the core information in a short-form format (e.g., summaries, key points, etc.) for easy digestibility. In one embodiment, content summarization and presentation module 208 may provide the top N results (where N is a system default number or a user-configurable number) along with other context obtained by the audio/video/text input module 202 and the uncertainty detection module 204 to an LLM with instructions to summarize the results so that the results fit within a particular space. For example, the instructions may indicate that the results should fit within the limits of a meeting UI display in a coherent way. References or links to the original source of the information may also be provided, which further allows the users to mark each piece of information as relevant or irrelevant to the current discussion/topic/question.

User feedback and learning module 210 may allow users or participants to provide feedback on the contextual search results (e.g., by indicating each search result as relevant or not relevant). The feedback may be used to enhance the system's understanding of what constitutes relevant information and may be used for future or subsequent discussions or communication sessions. In particular, the feedback may be used to finetune the dense retriever, the contextual search, re-ranking and relevance estimation module 206, and the LLM to ensure the specific item from the knowledge database and its summary has a higher or lower probability of being suggested in the future based on the user feedback.

Meeting UI display module 212 may receive the search results from content summarization and presentation module 208 and the references to the sources of information and display the contextual search results and extracted information within the provided search result interface of the communication session interface. The search result interface may include, for example, a window, sidebar, or panel that displays the relevant information, quotes, links, timestamps, or other relevant information for easy references. The search result interface may additionally include options for the participants to mark each search result item as relevant or not relevant.

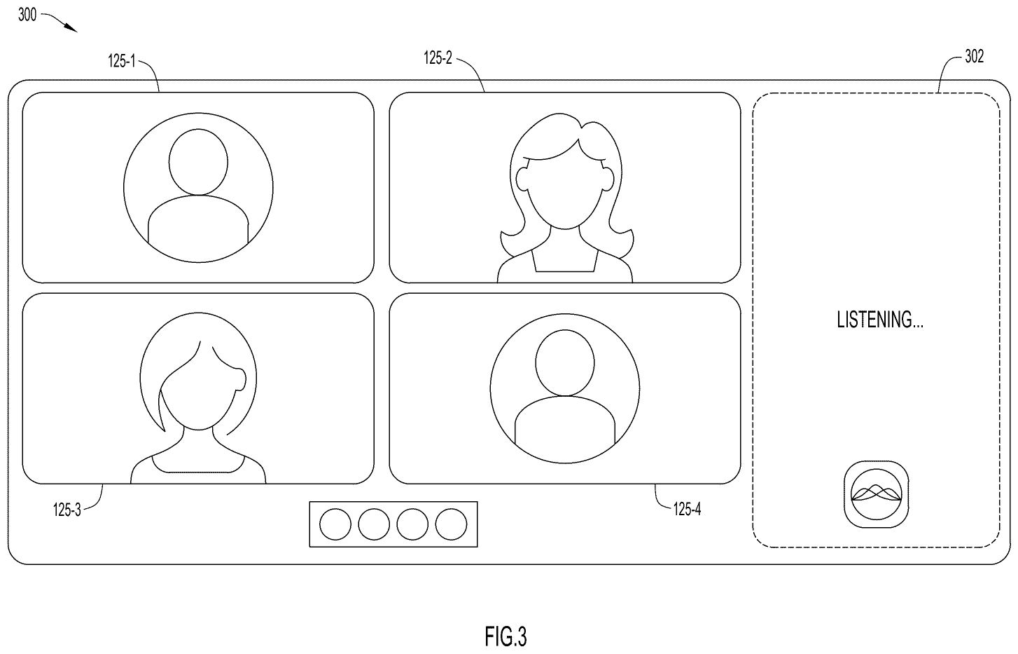

Reference is now made to FIGS. 3-6. FIGS. 3-6 illustrate user interfaces associated with an online videoconference in which information is requested, uncertainty cues are detected, and search results are presented. Although the example illustrated in FIGS. 3-6 is associated with an online videoconference, the example may be extended to various other communication sessions, such as voice calls, messaging chats using text, live discussions, and any other form of real-time discussion.

FIG. 3 is a user interface 300 illustrating on online meeting among users 125-1, 125-2, 125-3, and 125-4. User interface 300 includes an interface 302 associated with knowledge retrieval system 140. Interface 302 indicates that knowledge retrieval system 140 is currently “listening” to the online videoconference. As described above, knowledge retrieval system 140 may be observing the audio, video, and text of the videoconference to identify current topics of discussion, questions, information requested, uncertainty cues, and other information.

Although interface 302 illustrates the word “Listening.” being displayed, in some embodiments, interface 302 may display an icon indicating that the knowledge retrieval system 140 is observing the videoconference, or interface 302 may not display an indication that the knowledge retrieval system 140 is observing the videoconference. In some embodiments, user interface 300 may not include interface 302 until search results are displayed on the screen. In this embodiment, user interface 300 may display an indication that knowledge retrieval system 140 is observing the videoconference in a different area or user interface 300 may not display an indication that knowledge retrieval system 140 is observing the videoconference. In some cases, the participants may receive an indication prior to the videoconference that knowledge retrieval system 140 will be employed during the videoconference.

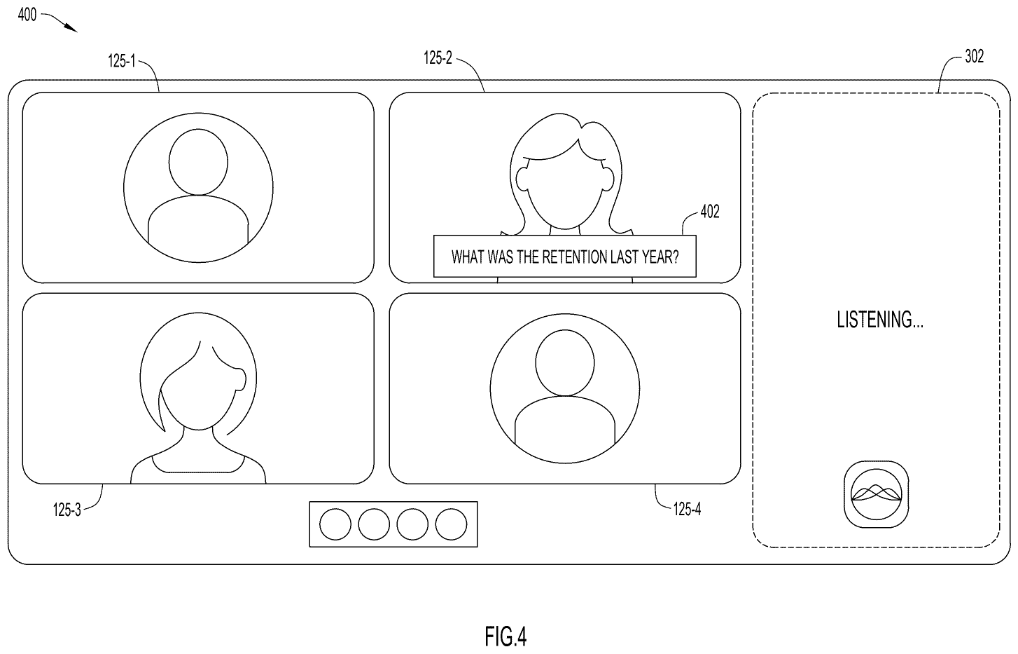

FIG. 4 is a user interface 400 illustrating the online videoconference in which user 125-2 asks the question 402 “What was the retention last year?” As shown in interface 302, knowledge retrieval system 140 is still “listening.” In this case, knowledge retrieval system 140 may identify that a question was asked and may continue listening or observing the videoconference to identify whether the question is answered or an uncertainty cue is observed.

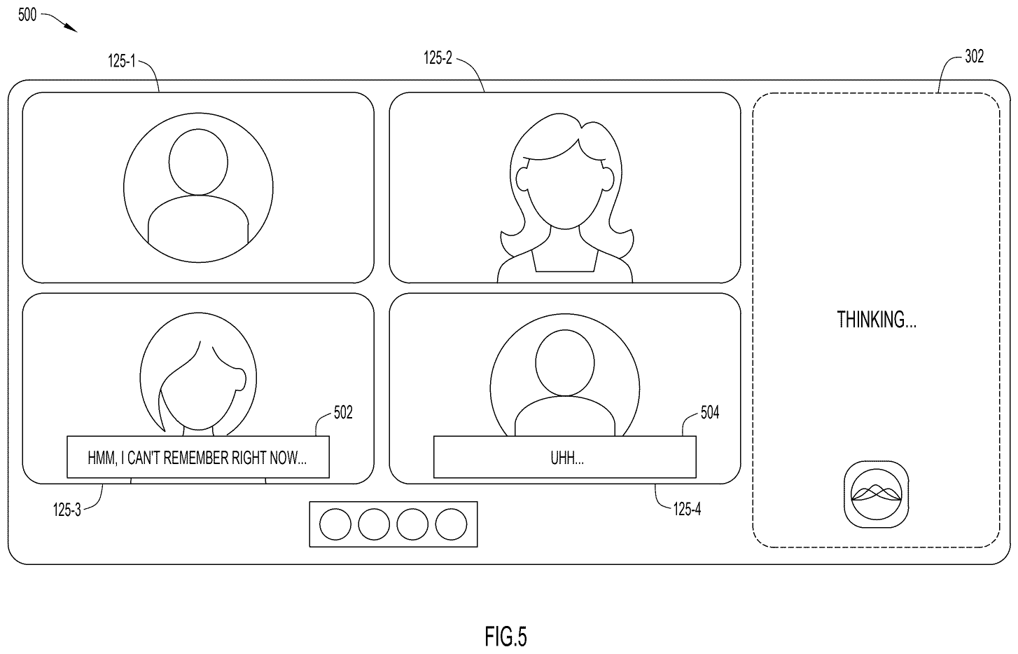

FIG. 5 is a user interface 500 illustrating the online videoconference in which the other participants are uncertain of the answer to the question 402. In particular, the uncertainty cue 502 is identified by knowledge retrieval system 140 when user 125-3 says “I can't remember right now . . . ” and the uncertainty cue 504 is identified when user 125-4 says the filler word “Uhh . . . ” In some embodiments, in addition to identifying uncertainty cue 502 and uncertainty cue 504, knowledge retrieval system 140 may quantify an amount of uncertainty among the other participants. For example, knowledge retrieval system 140 may calculate an uncertainty level and compare the uncertainty level to a threshold uncertainty level.

Knowledge retrieval system 140 may determine that the uncertainty level is above the threshold uncertainty level and may initiate a contextual search within a knowledge database. Knowledge retrieval system 140 may perform the search using keywords associated with the topic currently being discussed and/or the question 402 that was asked. In some embodiments, knowledge retrieval system 140 may determine which information (e.g., transcripts, documents, files, videos, etc.) within the knowledge database to search based on the keywords. Interface 302 may display the word “Thinking.” to indicate that the contextual search has been initiated. In some embodiments, interface 302 may display a different word or icon to indicate that a search has been initiated or interface 302 may not display an indication that the search has been initiated.

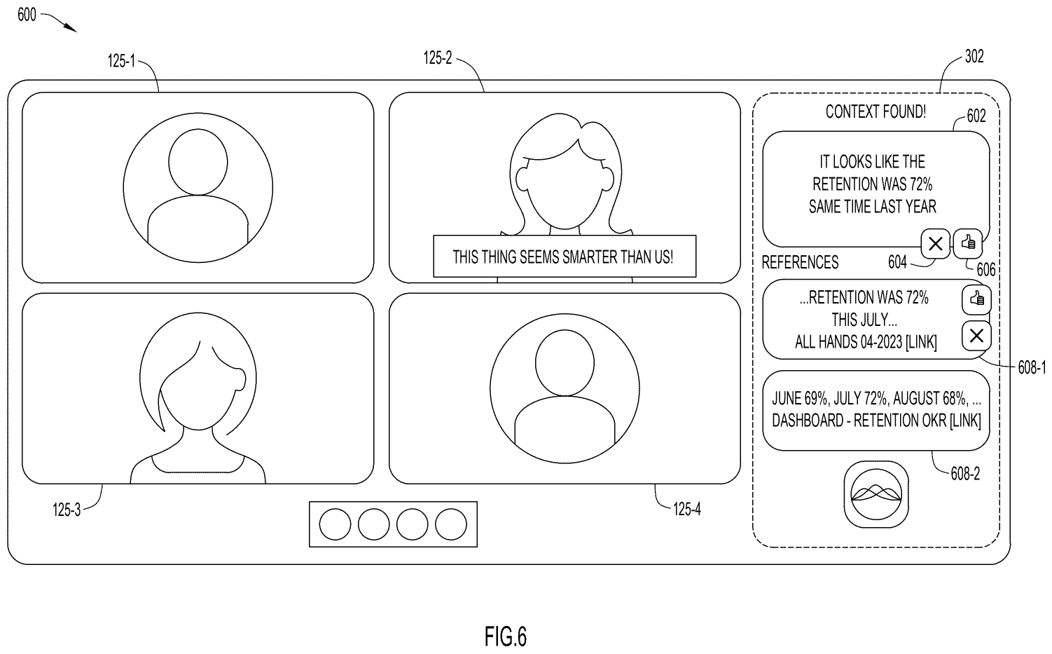

FIG. 6 is a user interface 600 illustrating the online videoconference with search results displayed. Knowledge retrieval system 140 may identify one or more of the most relevant search results and display the search result(s) in interface 302, optionally with references indicating where the search result(s) were identified. In this example, interface 302 may display search result 602 indicating that the retention was 72% at the same time last year. Interface 302 may additionally display references 608-1 and 608-2 indicating where the information in search result 602 was identified. In this example, references 608-1 and 608-2 include links to the references as well as a snippet of the relevant information gathered from the reference. In some embodiments, references 608-1 and 608-2 may include additional or different information.

Search result 602 additionally includes option 604 to indicate that the search result is not relevant and option 606 to indicate that the search result is relevant. Each participant may choose option 604 or option 606 to indicate whether the search result is relevant. References 608-1 and 608-2 may additionally include options to select whether each reference is relevant. Knowledge retrieval system 140 may use the feedback from the users when performing subsequent contextual searches.

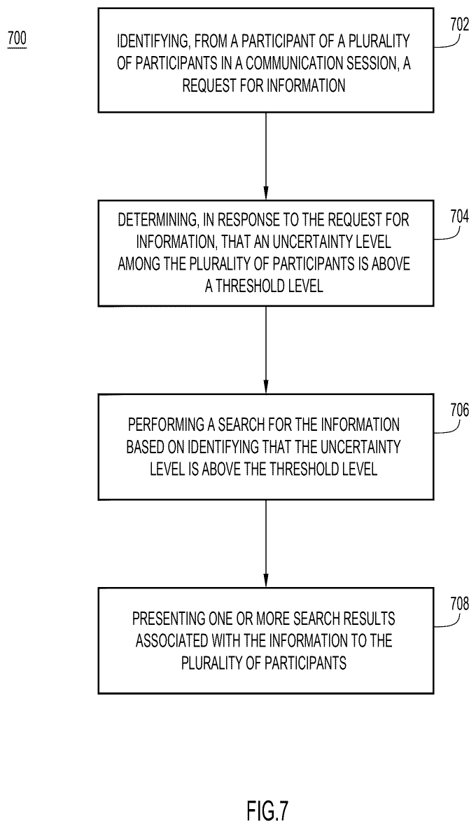

Reference is now made to FIG. 7. FIG. 7 is a flow chart illustrating a method 700 of presenting one or more search results in response to a request for information. Method 700 may be performed, for example, by knowledge retrieval system 140 in conjunction with user devices 120-1 to 120-N.

At 702, method 700 may include identifying, from a participant of a plurality of participants in a communication session, a request for information. For example, users 125-1 to 125-N may be participating in an online communication session (e.g., using user devices 120-1 to 120-N) and one of the participants may ask a question or request information. Knowledge retrieval system 140 may observe the communication session and may identify that the participant requested the information.

At 704, method 700 may include determining, in response to the request for information, that an uncertainty level among the plurality of participants is above a threshold level. For example, knowledge retrieval system 140 may identify one or more uncertainty cues among the plurality of participants. Knowledge retrieval system 140 may quantify the uncertainty cues and calculate an uncertainty level based on the uncertainty cues. Knowledge retrieval system 140 may compare the uncertainty level to a threshold level.

At 706, method 700 may include performing a search for the information based on identifying that the uncertainty level is above the threshold level. For example, knowledge retrieval system 140 may perform a search in data store 150 to identify search results associated with the information. The search may be performed based on keywords associated with the request for information and/or a topic being discussed during the online communication session. The search results may be analyzed to determine the most relevant search results based on the topic, the request for information, and/or the participant who requested the information.

At 708, method 700 may include presenting one or more search results associated with the information to the plurality of participants. For example, the most relevant one or more search results may be displayed to the plurality of participants. In addition, references indicating where the information was retrieved may additionally be displayed. The one or more search results and/or the references may be displayed in a user interface of the communication session. For example, the search results and/or references may be displayed in a window, sidebar, or panel of an interface associated with the communication session.

The features of method 700 tackle meeting efficiency by integrating advanced artificial intelligence (AI) technology to detect uncertainty cues and match real-time discussions with relevant contextual information from organizational knowledge bases. By seamlessly providing users with pertinent insights during discussions, embodiments presented herein streamline decision making processes, mitigate redundancy, and optimize outcomes, which ultimately enhances organizational productivity and effectiveness.

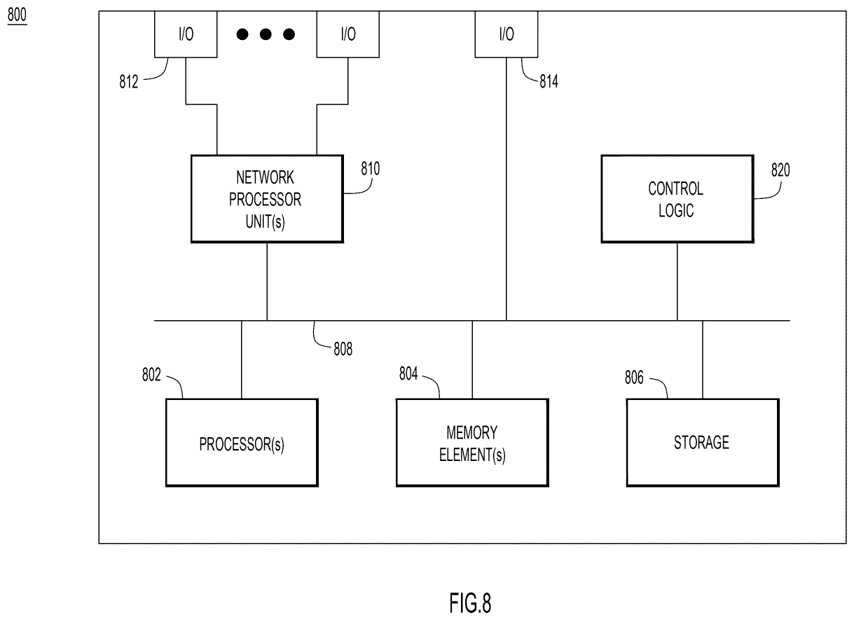

Referring to FIG. 8, FIG. 8 illustrates a hardware block diagram of a computing/computer device 800 that may perform functions associated with operations discussed herein in connection with the techniques depicted in FIGS. 1-7. In various embodiments, a computing device, such as computing device 800 or any combination of computing devices 800, may be configured as any devices as discussed for the techniques depicted in connection with FIGS. 1-7 in order to perform operations of the various techniques discussed herein.

In at least one embodiment, the computing device 800 may include one or more processor(s) 802, one or more memory element(s) 804, storage 806, a bus 808, one or more network processor unit(s) 810 interconnected with one or more network input/output (I/O) interface(s) 812, one or more I/O interface(s) 814, and control logic 820. In various embodiments, instructions associated with logic for computing device 800 can overlap in any manner and are not limited to the specific allocation of instructions and/or operations described herein. For example, computing device 800 may perform operations associated with user devices 120-1 to 120-N, application server(s) 130, knowledge retrieval system 140, etc.

In at least one embodiment, processor(s) 802 is/are at least one hardware processor configured to execute various tasks, operations and/or functions for computing device 800 as described herein according to software and/or instructions configured for computing device 800. Processor(s) 802 (e.g., a hardware processor) can execute any type of instructions associated with data to achieve the operations detailed herein. In one example, processor(s) 802 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 804 and/or storage 806 is/are configured to store data, information, software, and/or instructions associated with computing device 800, and/or logic configured for memory element(s) 804 and/or storage 806. For example, any logic described herein (e.g., control logic 820) can, in various embodiments, be stored for computing device 800 using any combination of memory element(s) 804 and/or storage 806. Note that in some embodiments, storage 806 can be consolidated with memory element(s) 804 (or vice versa), or can overlap/exist in any other suitable manner.

In at least one embodiment, bus 808 can be configured as an interface that enables one or more elements of computing device 800 to communicate in order to exchange information and/or data. Bus 808 can be implemented with any architecture designed for passing control, data and/or information between processors, memory elements/storage, peripheral devices, and/or any other hardware and/or software components that may be configured for computing device 800. In at least one embodiment, bus 808 may be implemented as a fast kernel-hosted interconnect, potentially using shared memory between processes (e.g., logic), which can enable efficient communication paths between the processes.

In various embodiments, network processor unit(s) 810 may enable communication between computing device 800 and other systems, entities, etc., via network I/O interface(s) 812 (wired and/or wireless) to facilitate operations discussed for various embodiments described herein. Examples of wireless communication capabilities include short-range wireless communication (e.g., Bluetooth), wide area wireless communication (e.g., 4G, 5G, etc.). In various embodiments, network processor unit(s) 810 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 800 and other systems, entities, etc. to facilitate operations for various embodiments described herein. In various embodiments, network I/O interface(s) 812 can be configured as one or more Ethernet port(s), Fibre Channel ports, any other I/O port(s), and/or antenna(s)/antenna array(s) now known or hereafter developed. Thus, the network processor unit(s) 810 and/or network I/O interface(s) 812 may include suitable interfaces for receiving, transmitting, and/or otherwise communicating data and/or information in a network environment.

I/O interface(s) 814 allow for input and output of data and/or information with other entities that may be connected to computer device 800. For example, I/O interface(s) 814 may provide a connection to external devices such as a keyboard, keypad, a touch screen, and/or any other suitable input and/or output device now known or hereafter developed. This may be the case, in particular, when the computer device 800 serves as a user device described herein. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, such as a display, particularly when the computer device 800 serves as a user device as described herein.

In various embodiments, control logic 820 can include instructions that, when executed, cause processor(s) 802 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 820) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 804 and/or storage 806 can store data, software, code, instructions (e.g., processor instructions), logic, parameters, combinations thereof, and/or the like used for operations described herein. This includes memory element(s) 804 and/or storage 806 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

In one form, a computer-implemented method is provided that comprises identifying, from a participant of a plurality of participants in a communication session, a request for information; determining, in response to the request for information, that an uncertainty level among the plurality of participants is above a threshold level; performing a search for the information based on identifying that the uncertainty level is above the threshold level; and presenting one or more search results associated with the information to the plurality of participants.

In one example, the computer-implemented method further comprises searching one or more data stores based on the request for the information; obtaining a plurality of search results; and filtering the plurality of search results using a Large Language Model (LLM) to identify the one or more search results. In another example, the LLM is trained using transcripts of previous communication sessions associated with the participant, and filtering the plurality of search results using the LLM includes: instructing the LLM to filter the plurality of search results based on the transcripts of the previous communication sessions.

In another example, determining that the uncertainty level among the plurality of participants is above the threshold level includes: using a first machine learning model to identify patterns and/or behaviors associated with the plurality of participants that are indicative of uncertainty; quantifying the patterns and/or behaviors to identify the uncertainty level; and comparing the uncertainty level to the threshold level. In another example, the patterns and/or behaviors include an increased usage of filler words, an indication of a hesitation, and/or an indication of confusion.

In another example, using the first machine learning model to identify the patterns and/or behaviors includes: obtaining audio data and/or video data associated with the communication session; dividing the audio data and/or video data into segments; transmitting the segments to a second machine learning model to generate high dimensional representations of the audio data and/or the video data; and transmitting the high dimensional representations of the audio data and/or the video data to the first machine learning model to identify the patterns and/or behaviors. In another example, the computer-implemented method further includes obtaining feedback associated with the one or more search results from one or more of the plurality of participants; and using the feedback for performing one or more subsequent searches. In another example, presenting the one or more search results includes presenting the one or more search results within an interface of the communication session.

In another form, an apparatus is provided including: a memory; a network interface configured to enable network communication; and a processor, wherein the processor is configured to perform operations including: identifying, from a participant of a plurality of participants in a communication session, a request for information; determining, in response to the request for information, that an uncertainty level among the plurality of participants is above a threshold level; performing a search for the information based on identifying that the uncertainty level is above the threshold level; and presenting one or more search results associated with the information to the plurality of participants.

In yet another form, one or more non-transitory computer readable storage media encoded with instructions are provided that, when executed by a processor of a technical support system, cause the processor to execute a method including: identifying, from a participant of a plurality of participants in a communication session, a request for information; determining, in response to the request for information, that an uncertainty level among the plurality of participants is above a threshold level; performing a search for the information based on identifying that the uncertainty level is above the threshold level; and presenting one or more search results associated with the information to the plurality of participants.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IOT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

1. A computer-implemented method comprising:
identifying, from a first participant of a plurality of participants participating in an online videoconference a request for information from one or more second participants of the plurality of participants;
determining, in response to the request for information, that an uncertainty level associated with the one or more second participants is above a threshold level;
performing a search for the information based on identifying that the uncertainty level is above the threshold level, wherein performing the search includes searching one or more data stores using keywords associated with a topic being discussed when the request for information was identified; and
presenting one or more search results associated with the information in a user interface of the online videoconference for display to each of the plurality of participants while the online videoconference is occurring.

2. The computer-implemented method of claim 1, wherein performing the search for the information includes:
obtaining a plurality of search results; and
filtering the plurality of search results using a Large Language Model (LLM) to identify the one or more search results.

3. The computer-implemented method of claim 2, wherein the LLM is trained using transcripts of previous communication sessions associated with the first participant, and wherein filtering the plurality of search results using the LLM comprises:
instructing the LLM to filter the plurality of search results based on the transcripts of the previous communication sessions.

4. The computer-implemented method of claim 1, wherein determining that the uncertainty level among the plurality of participants is above the threshold level comprises:
using a first machine learning model to identify patterns and/or behaviors associated with the plurality of participants that are indicative of uncertainty;
quantifying the patterns and/or behaviors to identify the uncertainty level; and
comparing the uncertainty level to the threshold level.

5. The computer-implemented method of claim 4, wherein the patterns and/or behaviors include an increased usage of filler words, an indication of a hesitation, and/or an indication of confusion.

6. The computer-implemented method of claim 4, wherein using the first machine learning model to identify the patterns and/or behaviors comprises:
obtaining audio data and/or video data associated with the online videoconference;
dividing the audio data and/or video data into segments;
transmitting the segments to a second machine learning model to generate high dimensional representations of the audio data and/or the video data; and
transmitting the high dimensional representations of the audio data and/or the video data to the first machine learning model to identify the patterns and/or behaviors.

7. The computer-implemented method of claim 1, further comprising:
obtaining feedback associated with the one or more search results from one or more of the plurality of participants; and
using the feedback for performing one or more subsequent searches.

8. (canceled)

9. An apparatus comprising:
a memory;
a network interface configured to enable network communication; and
a processor, wherein the processor is configured to perform operations comprising:
identifying, from a first participant of a plurality of participants in an online videoconference, a request for information from one or more second participants of the plurality of participants;
determining, in response to the request for information, that an uncertainty level associated with the one or more second participants is above a threshold level;
performing, based on identifying that the uncertainty level is above the threshold level, a search for the information in one or more data stores using keywords associated with a topic being discussed when the request for information was identified; and
presenting one or more search results associated with the information in a user interface of the online videoconference for display to each of the plurality of participants while the online videoconference is occurring.

10. The apparatus of claim 9, wherein, when performing the search for the information, the processor is configured to perform operations comprising:
searching the one or more data stores based on the request for the information;
obtaining a plurality of search results; and
filtering the plurality of search results using a Large Language Model (LLM) to identify the one or more search results.

11. The apparatus of claim 10, wherein the LLM is trained using transcripts of previous communication sessions associated with the first participant, and wherein, when filtering the plurality of search results using the LLM, the processor is configured to perform operations comprising:
instructing the LLM to filter the plurality of search results based on the transcripts of the previous communication sessions.

12. The apparatus of claim 9, wherein, when determining that the uncertainty level among the plurality of participants is above the threshold level, the processor is further configured to perform operations comprising:
using a first machine learning model to identify patterns and/or behaviors associated with the plurality of participants that are indicative of uncertainty;
quantifying the patterns and/or behaviors to identify the uncertainty level; and
comparing the uncertainty level to the threshold level.

13. The apparatus of claim 12, wherein the patterns and/or behaviors include an increased usage of filler words, an indication of a hesitation, and/or an indication of confusion.

14. The apparatus of claim 12, wherein, when using the first machine learning model to identify the patterns and/or behaviors, the processor is further configured to perform operations comprising:
obtaining audio data and/or video data associated with the online videoconference;
dividing the audio data and/or video data into segments;
transmitting the segments to a second machine learning model to generate high dimensional representations of the audio data and/or the video data; and
transmitting the high dimensional representations of the audio data and/or the video data to the first machine learning model to identify the patterns and/or behaviors.

15. The apparatus of claim 9, wherein the processor is further configured to perform operations comprising:
obtaining feedback associated with the one or more search results from one or more of the plurality of participants; and
using the feedback for performing one or more subsequent searches.

16. One or more non-transitory computer readable storage media encoded with instructions that, when executed by a processor of a technical support system, cause the processor to execute a method comprising:
identifying, from a first participant of a plurality of participants in an online videoconference, a request for information from one or more second participants of the plurality of participants;
determining, in response to the request for information, that an uncertainty level associated with the one or more second participants is above a threshold level;
performing a search for the information based on identifying that the uncertainty level is above the threshold level, wherein performing the search includes searching one or more data stores using keywords associated with a topic being discussed when the request for information was identified; and
presenting one or more search results associated with the information in a user interface of the online videoconference for display to each of the plurality of participants while the online videoconference is occurring.

17. The one or more non-transitory computer readable storage media of claim 16, wherein performing the search for the information includes:
obtaining a plurality of search results; and
filtering the plurality of search results using a Large Language Model (LLM) to identify the one or more search results.

18. The one or more non-transitory computer readable storage media of claim 17, wherein the LLM is trained using transcripts of previous communication sessions associated with the first participant, and wherein filtering the plurality of search results using the LLM comprises:
instructing the LLM to filter the plurality of search results based on the transcripts of the previous communication sessions.

19. The one or more non-transitory computer readable storage media of claim 16, wherein determining that the uncertainty level among the plurality of participants is above the threshold level comprises:
using a first machine learning model to identify patterns and/or behaviors associated with the plurality of participants that are indicative of uncertainty;
quantifying the patterns and/or behaviors to identify the uncertainty level; and
comparing the uncertainty level to the threshold level.

20. The one or more non-transitory computer readable storage media of claim 16, further comprising:
obtaining feedback associated with the one or more search results from one or more of the plurality of participants; and
using the feedback for performing one or more subsequent searches.

21. The one or more non-transitory computer readable storage media of claim 19, wherein the patterns and/or behaviors include an increased usage of filler words, an indication of a hesitation, and/or an indication of confusion.
